(19) United States
(12) Patent Application Publication
(10) Pub. No.: US 2019/0053144 A1
(43) Pub. Date: Feb. 14, 2019

(54) CELLULAR DEVICE CELL SELECTION

(71) Applicant: VODAFONE IP LICENSING LIMITED, Newbury, Berkshire (GB)

(72) Inventors: Siva SUBRAMANI, Newbury Berkshire (GB); Hisham EL SHAER, Newbury Berkshire (GB)

(21) Appl. No.: 16/076,414

(22) PCT Filed: Feb. 13, 2017
(86) PCT No.: PCT/GB2017/050379

§ 371 Date: Aug. 8, 2018

(30) Foreign Application Priority Data
Feb. 12, 2016 (GB) 1602592.6

(51) Int. Cl. H04W 48/18; H04B 17/309; H04W 52/14; H04B 17/10

(52) U.S. Cl. CPC H04W 48/18; H04B 17/102; H04W 52/146; H04B 17/309

(57) ABSTRACT

A cell is selected, from which a cellular device is to receive service in a cellular network. A selection metric is determined for each cell of a plurality of cells. Each selection metric is based on a transmission power level for the respective cell and a received power level for the respective cell at the cellular device, such that the selection metric reflects an uplink performance characteristic between the cellular device and the respective cell. A cell is selected based on the selection metric for each cell. Also provided is a technique for communicating from the cell over a broadcast channel or a system information channel, information about a transmission power level for the cell, for reception by a cellular device that is selecting a cell from the plurality of cells from which the cellular device is to receive service.

### TECHNICAL FIELD OF THE INVENTION

The invention concerns a method for selecting a cell from which a cellular device is to receive service, a method of operating a cell in a cellular network, an associated computer program and an associated entity for operation in a cellular network (such as a base station or cellular device).

### BACKGROUND TO THE INVENTION

Cell selection and re-selection is a well-known issue in cellular network management. The development of new cellular network-based technologies, such as Narrow Band Internet of Things (NB-IoT), creates new challenges in this area. This technology is being standardised by the Third Generation Partnership Project (3GPP). An objective behind NB-IoT is to develop a new Radio Access Technology (RAT), to deliver an ultra-low complexity IoT system that delivers 20 dB extended coverage (compared to GPRS), allows devices with a battery life of over 10 years and with a network system supporting a large number of devices. Implementing a workable cell-selection and re-selection technique with such constraints is not straightforward.

The NB-IoT RAT is intended to be based on existing 3GPP Long Term Evolution (LTE) technologies. In existing LTE networks, decisions for cell selection and cell reselection are based on measurements of the downlink signal quality, such as the Reference Signal Received Power (RSRP) and Reference Signal Received Quality (RSRQ) metrics. This is explained in 3GPP Technical Specification (TS) 36.304 V13.0.0. The maximum cellular device transmission power can be used as part of the cell selection decision calculations.

However, the NB-IoT technology has a number of distinct characteristics that can make cell selection and re-selection further problematic. Most IoT (or sensor) data traffic is expected to be communicated via the uplink. Moreover, a narrow uplink transmission bandwidth (for example 3.75 kHz) is proposed and as a consequence, the transmission is time-expanded. In other words, a longer (2 ms or 4 ms) subframe may be used on the uplink, instead of a 1 ms subframe known in existing LTE architectures. The signals are therefore transmitted over a longer period of time. Additionally or alternatively, many repetitions of the signals may be used to improve coverage. This new RAT can make cell selection and re-selection more complex.

NB-IoT has 3 different modes of operation: stand-alone, guard-band and in-band. These are illustrated with reference to FIG. 1, in which there are schematically shown spectral profiles for the different modes of NB-IoT operation. The stand-alone operation (a) is deployed by taking out 200 kHz from an existing allocated band (such as a band allocated to GSM) for NB-IoT. In-band deployment (b) considers taking 200 kHz (one Physical Resource Block, PRB) inside an LTE transmission bandwidth (typically 10 MHz). Guard-band deployment (c) takes out 200 kHz in the guard band of the LTE carrier. These differing deployment modes add a further complexity to cell selection and re-selection.

Another feature of NB-IoT is power spectral density (PSD) boosting. Referring to FIG. 2, there are depicted PSD boosting spectral profiles for two of the operation modes shown in FIG. 1, as examples. If 10 MHz LTE is considered, the output power of E-UTRA (LTE) base stations is 46 dBm over 50 Resource Blocks (RBs), which is 29 dBm/RB. NB-IoT may operate within one RB (200 kHz for this example), so this measurement of PSD may represent the cell transmission power for NB-IoT operation. A PSD of 29 dBm may not be sufficient to reach the cellular devices in extreme coverage, so the PSD may be boosted for the NB-IoT RBs. In other words, the NB-IoT PSD is increased with reference to the PSD of the LTE carrier.

It is expected that PSD boosting may be variable and boosting of 3 dB, 4 dB, 6 dB or even 9 dB may be possible. Hence, if the cell has a 29 dBm PSD, its transmission power for NB-IoT may be 32 dBm, 33 dBm, 35 dBm or 38 dBm after PSD boosting. In stand-alone deployment (FIG. 1(a)), the 200 kHz bandwidth signal can have the same transmission power as a GSM base station, for example 43 dBm. FIG. 2 therefore shows PSD boosting: for in-band deployment (i), with a PSD boost of 6 dB over the 29 dBm of the LTE carrier; and for guard-band deployment (ii), with a PSD boost of 6 to 9 dB over the LTE carrier.

A further deployment scenario for NB-IoT is within heterogeneous networks, especially in which the cellular device is served by either a macro-cell or a small cell. This can also give rise to differences in base station transmission powers.

With a wide range of deployment scenarios, varying PSD possibilities, different RAT structure and uplink-centric traffic nature of the NB-IoT RAT, the use of downlink signal quality measurements for cell selection and re-selection in LTE will be highly sub-optimal when applied to NB-IoT. An improved cell selection and re-selection technique is therefore desirable.

### SUMMARY OF THE INVENTION

Against this background, the present invention provides a method for selecting a cell from which a cellular device is to receive service in accordance with claim 1 and a method of operating a cell in a cellular network comprising a plurality of cells in line with claim 13. Also provided is an entity for a cellular network according to claim 16. The invention may also be embodied in the form of programmable logic, firmware or other configurable system. Other preferred features are disclosed with reference to the claims and in the description below.

Thus, a technique for selecting a cell from which a cellular device is to receive service is provided. The cell is selected from a plurality of cells in a cellular network. A selection metric is determined for each cell of the plurality of cells. Each selection metric is based on a transmission power level for the respective cell and a received power level for the respective cell at the cellular device. The selection metric may reflect an uplink performance characteristic between the cellular device and the respective cell. A cell is selected from the plurality of cells based on the respective selection metric for each cell. It may be understood that a cell transmission power is the base station transmission power for the cell. Advantageously, the transmission power level for the respective cell is the cell's transmission power level over the bandwidth for transmissions to the cellular device. In particular, the cell and cellular device may be operating over a relatively narrow bandwidth.

By using the cell's transmission power with the received power level at the cellular device, a more accurate assessment of path loss can be obtained for all deployment scenarios. This assessment of path loss will normally apply equally to the uplink as well as the downlink. In contrast with existing systems, which compare downlink qualities, this will allow uplink and/or downlink qualities to be measured. It should be noted that existing approaches do not use the cell transmission power. Cell selection criteria using a maximum transmission power of the User Equipment (UE) are known, but this is quite different from using the transmission power of the cell (base station). The techniques described herein are of low complexity and therefore energy efficient. They may conserve battery life of the device.

In one aspect, it is envisaged that the cellular device, such as an IoT device, chooses the cell that is most optimised for the uplink. To enable this uplink-optimised cell selection, changes to the existing 3GPP LTE specifications cell selection and cell-reselection procedures may be proposed.

An aspect may be considered in which a cell in a cellular network, comprising a plurality of cells, is operated. Here, information about a transmission power level for the cell is communicated from the cell over a broadcast channel or a system information channel, for reception by a cellular device that is selecting a cell from the plurality of cell from which the cellular device is to receive service. Broadcasting a transmission power level for the cell, in particular the power level for transmissions to NB-IoT devices, may allow the cellular device to make decisions about cell selection and re-selection more accurately based on path loss (which may apply to both uplink and downlink), rather than information that is specific to the downlink. If the cell transmits a relatively wide bandwidth carrier (such as LTE) and communicates with the cellular device over a relatively narrow bandwidth, the information about the transmission power level may comprise: information about a transmission power level for the relatively wide bandwidth carrier; and information about power spectral density boosting in respect of the narrow bandwidth used for communicating with the cellular device.

The cellular device measures the received power level for each cell of the plurality of cells, beneficially over one or multiple subframes of a physical layer protocol of the cellular network and/or until an accuracy of the measured received power level is within 3 dB. In other words, this provides an extended measurement period. Extending the measurement time can be of significant benefit in a relatively narrow band system, for instance.

In practice for cell selection and re-selection, a coupling gain may be used rather than a path loss. The coupling gain for each cell may represent a gain from the transmission power level for the respective cell to the received power level for the respective cell at the cellular device. Thus, the coupling gain may be considered the sum of the inverse of the path loss (which is effectively a gain) and any other gains in the signal path, such as antenna gains or shadowing gains. Typically, the coupling gain will be negative on a decibel scale. The selection metric for each of the plurality of cells may be the coupling gain or a combination (such as a weighted average) of the coupling gain and at least one further parameter. The further parameter may be based on the downlink signal measurements, such as the received power. If a weighted average is used, the weights may be adjusted dependent on the split between uplink and downlink data traffic for the cellular device. The cellular device may set the weights.

The selection metric and/or the transmission power level for the cell may be stored at the cellular device with other stored information about the cell. Therefore, the cellular device can make a decision about cell re-selection based on the stored information.

### BRIEF DESCRIPTION OF THE DRAWINGS

The invention may be put into practice in various ways, one of which will now be described by way of example only and with reference to the accompanying drawing in which:

FIG. 1 schematically shows existing spectral profiles for three different modes of Narrow Band Internet of Things (NB-IoT) operation;

FIG. 2 depicts known PSD boosting spectral profiles for two of the operation modes shown in FIG. 1;

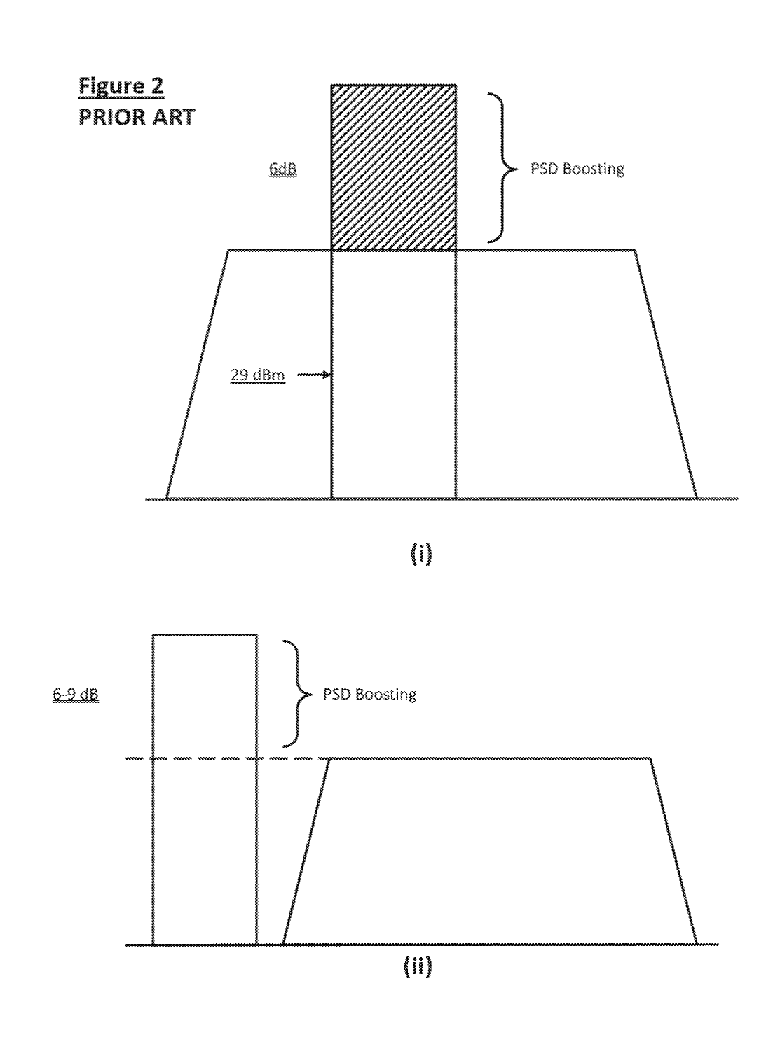

FIG. 3 diagrammatically shows a cellular device selecting between two cells;

FIG. 4 diagrammatically shows a cellular device selecting between three cells, each of which having a different NB-IoT mode of operation;

FIG. 5 illustrates a flowchart of a mode of operation for a cellular device in accordance with the disclosure; and

FIG. 6 diagrammatically shows a cellular device selecting cells in a heterogeneous network mode.

### DETAILED DESCRIPTION OF A PREFERRED EMBODIMENT

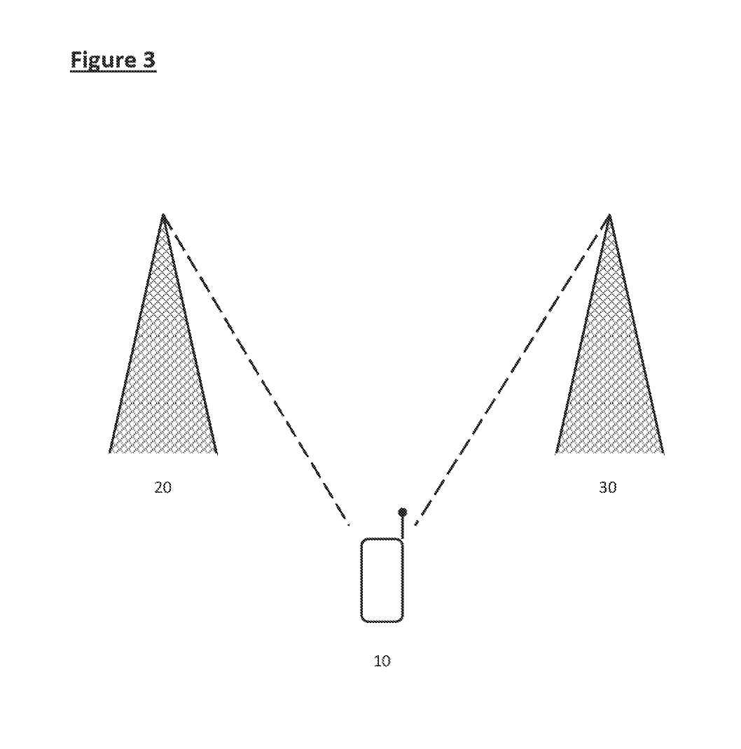

Referring to FIG. 3, there is diagrammatically shown a cellular device 10, selecting between a first cell 20 and a second cell 30. The cellular device 10 is an Internet of Things (IoT) device, in particular a Narrow Band (NB) IoT device. By narrow band, a bandwidth that is: no more than 1 or 2 resource blocks of a wide-band LTE carrier (a resource block may be considered 180 kHz or 200 kHz wide); no more than 200 kHz or 180 kHz; or significantly narrow in comparison with a wide-band carrier operating on the same frequency band may be considered, for instance. Alternative definitions of narrow band can be considered. The techniques disclosed herein are also applicable to systems which operate using multiple such narrow band carriers.

Using the terminology of 3GPP, the cellular device 10 can also be referred to as a User Equipment (UE) and it can also be referred to as a mobile terminal (even if the device is not strictly mobile). In the IoT UE RAT, cell selection, reselection and handover are based on the Reference Signal Received Power (RSRP). Sometimes, the Reference Signal Received Quality (RSRQ) is also used, if RSRP is not sufficient for a decision to be made. The RSRP metric is a good indicator of downlink signal strength and can be used to compare cell downlinks. However, it may not always be a reliable way to compare uplinks between cells.

The IoT device 10 is a low complex cellular device, comprising (but not shown) at least a cellular air interface transmitter, a cellular air interface receiver and a processor. Once it boots up, an initial cell search is carried out and followed by a cell selection procedure. In the cell search procedure, the device 10 scans the supported frequency bands (E-UTRA) to read the Physical Broadcast Channel (PBCH) and extracts the Master Information Block (MIB). The MIB carries the most essential system information followed by System Information Block (SIB) Type 1. Reading MIB and SIB Type 1 are prerequisites of the system as defined by 3GPP. The device 10 only knows after reading the SIB Type 1 of a cell, if that cell belongs to its operator's Public Land Mobile Network (PLMN), based on the PLMN Identity. The device 10 therefore checks whether at least once cell from its operator's PLMN is available. It then selects a PLMN for its operation.

After selecting a PLMN, the cell selection process starts. The device 10 creates a candidate list of potential cells on which to camp on by using two search procedures: (i) initial cell selection; or (ii) stored information selection. In (i) initial cell selection, measurements are made about the cells, as the device 10 has no knowledge of the RF channels and therefore scans the supported bands to find a suitable cell (idle mode measurements). During this scanning, an RSRP value is estimated for each cell. For (ii) stored information selection, stored information with the carrier frequency and optionally previous cell selection and measurement parameters from the control Information Element (IE) may be used for the cell selection decision. This may speed up the cell selection process. It should be noted that the device 10 generally reads the MIB and SIB Type 1 even for stored cells, because the device 10 reads the SIB Type 1 to know the PLMN identity.

The device 10 measures the RSRP (average received power) in the downlink Reference Symbols (RS) for antenna port 0 (that is, OFDM symbol 0 and 4 in a slot). Under existing 3GPP standards, the device 10 is expected to average the measurement over a time slot (0.5 ms). However, an absolute time value is not specified by the standard specification. Instead, the specification sets an accuracy requirement of 6 to 11 dB. Nevertheless, it is understood that this is achievable when measuring over one time slot.

One technique to improve the performance of cellular devices, in particular the NB-IoT device 10 is to change this measurement. Due to the narrow band operation, one time slot (0.5 ms) of measurement may be difficult to achieve a reasonable accuracy. Also, an accuracy of 6 to 11 dB is too large a variance. Therefore, a longer measurement, for example within 1 or 2 subframes, or until the accuracy is within 3 dB is proposed. An LTE subframe has a duration of 2 slots.

In general terms, this may be considered a method of operating a cellular device (in particular, an IoT device) within a cellular network, comprising: measuring a received power level for a cell of the cellular network at the cellular device, the measuring being over one or multiple subframes of a physical layer protocol of the cellular network and/or being made until an accuracy of the measured received power level is within 3 dB. This method may be combined with any other method, feature and/or aspect disclosed herein, as indicated below.

For the device 10 to make a decision about cell selection based on received power measurements, such as RSRP, it can advantageously use the cell transmission powers. These could be carried by the cell broadcasts or system information transmissions, for example, the SIB Type 1. In particular, the cell may transmit both the cell base (wideband) transmission power and PSD boosting information. The 3GPP specification may be modified to carry this additional information and the cell transmission power and PSD boost level could be included as ‘reserved’ bits. Only few bits may be required to provide this information.

Generally, this may be considered a method of operating a cell in a cellular network comprising a plurality of cells. The method comprises: communicating from the cell over a broadcast channel or a system information channel, information about a transmission power level for the cell, for reception by a cellular device that is selecting a cell from the plurality of cells from which the cellular device is to receive service. The cell may transmit a relatively wide bandwidth carrier (for example, for LTE) and communicate with the cellular device over a relatively narrow bandwidth. Then, the information about the transmission power level may comprise: information about a transmission power level for the relatively wide bandwidth carrier; and information about power spectral density boosting in respect of the narrow bandwidth used for communicating with the cellular device.

A new selection criterion therefore should use the cell transmission power together with the signal power received from the cell at the cellular device. In general terms, there is therefore provided a method for selecting a cell from which a cellular device is to receive service. The cell is selected from a plurality of cells in a cellular network. The method comprises: determining a selection metric for each cell of the plurality of cells, each selection metric being based on a transmission power level for the respective cell and a received power level for the respective cell at the cellular device; and selecting a cell from the plurality of cells based on the respective selection metric for each cell. Advantageously, the selection metric reflects an uplink performance characteristic between the cellular device and the respective cell, in particular an ease in transmitting data over (or an error characteristic of) that uplink. Optionally, at least one cell from the plurality of cells transmits a relatively wide bandwidth carrier and communicates with the cellular device over a relatively narrow bandwidth. In this case, the transmission power level for the cell may be in respect of the narrow bandwidth used for communicating with the cellular device. In some embodiments, the cell transmits to the cellular device over a narrow bandwidth, in line with the definition for narrow band noted above.

Using the received cell transmission power (Tx_Power) and PSD boosting (PSD_Boosting) information, combined with the measured RSRP value, an estimate of path loss and shadowing in the device's 10 current location may be determined. Rather than calculating path loss however, the device preferably calculates or estimates a coupling gain. The coupling gain is effectively the sum of the inverse of the path loss and any other gains in the signal path, such as antenna gains or shadowing gains (the coupling gain may therefore be a form of channel gain).

In terms of the general method discussed above, the step of determining a selection metric for each cell of the plurality of cells may comprise determining a coupling gain for each cell. The coupling gain may represent a gain from the transmission power level for the respective cell to the received power level for the respective cell at the cellular device.

Thus, the coupling gain (Coupling_gain) can be determined using the following formula (where dB indicates that the quantity is specified in decibels):

Coupling_gain(dB)=RSRP(dB)−(Tx_power(dB)+PSD_boosting(dB))

In the linear domain, the formula may be specified as:

Coupling_gain=RSRP/(Tx_power*PSD_boosting).

As an example, if the RSRP is −140 dB, Tx_power is 10 dB and PSD_boosting is 6 dB, the Coupling_gain is −156 dB.

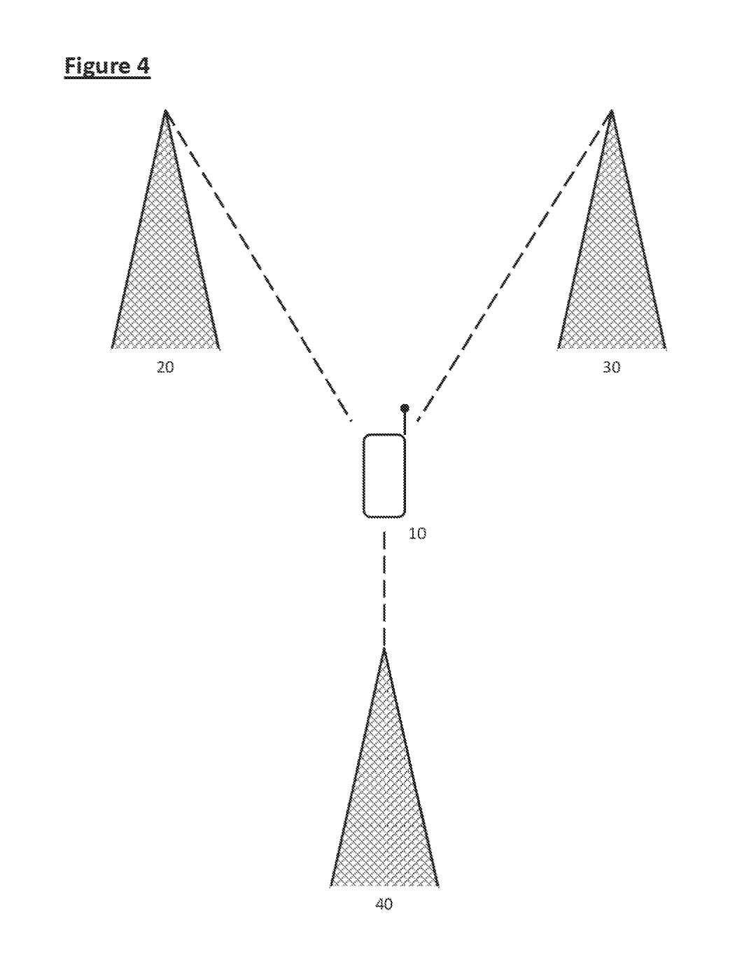

A further example of this is now considered with reference to FIG. 4, in which there is diagrammatically shown a cellular device 10 selecting between three cells, each of which having a different NB-IoT mode of operation. The first cell 20 uses an in-band mode of operation, with a cell transmission power of 29 dBm and a PSD boosting of 6 dB. The second cell 30 uses a guard-band mode of operation, with a cell transmission power of 29 dBm and a PSD boosting of 4 dB. The third cell 40 uses a stand-alone mode of operation, with a cell transmission power of 43 dBm.

If an RSRP of −120 dB is measured at the device 10 from all three cells, a cell selection decision based on RSRP alone would not differentiate between the cells. However, the coupling gain for the first cell 20 is −155 dB, for the second cell 30 it is −153 dB and for the third cell 40 it is −163 dB. Using coupling gain alone, the second cell 30 would be selected, as having the highest coupling gain (or smallest path loss). This is evident, because the second cell is transmitting to the device 10 with a smaller transmission power than the other cells and yet achieves the same received signal power.

The method of cell selection will now be discussed. Some of this is similar to existing cell selection techniques, such as discussed in 3GPP TS 36.304 V13.0.0, which specifies cell selection criteria “S” that is fulfilled when:

S_rxlev>0 and S_qual>0, wherein: S_rxlev=Cell selection received level value (dB); and S_qual=Cell selection quality value (dB).

The coupling gain for only those cells meeting this minimal criterion may be determined and the cell with the highest coupling gain selected, as discussed above. The “S” criterion may further be modified to include the coupling gain. Optionally, a criterion based on coupling gain alone could replace the criterion noted above.

In the context of the general terms above, the method may further comprise identifying some cells from the plurality of cells that meet a cell selection criterion (such as the “S” criterion). Then, the step of selecting a cell from a plurality of cells may comprise comparing the respective selection metrics of each of the identified some cells. The cell selection criterion preferably defines one or more thresholds. Advantageously, the step of selecting a cell from a plurality of cells comprises selecting the cell from the identified some cells with a selection metric corresponding with the best performance, in particular if the mobile is not already receiving service from a cell. The best performance may correspond with the maximum selection metric, depending on how the selection metric is defined (the minimum selection metric may be another possibility, if certain definitions are used).

In some embodiments, cell selection could be based on coupling gain only. Alternatively and more preferably, cell selection may be based on coupling gain in combination with another parameter. Equivalently using the general terms noted above, the selection metric for each cell of the plurality of cells may be defined by the coupling gain for the respective cell and at least one further parameter of the respective cell. For example, the selection metric for each of the plurality of cells may be a weighted average of the coupling gain and the at least one further parameter. The at least one further parameter may comprise a parameter based on the received power level for the respective cell at the cellular device, for example a parameter based on the RSRP (such as the RSRP).

One way to modify the “S” criterion is to select the cell that best suits the device's split of uplink to downlink traffic requirements, for instance by the following formula:

max(w₁*Coupling_gain+w₂*RSRP).

Here, w₁ and w₂ are weighting factors that are set at the device and preferably based on the device's traffic requirements. An example may be considered: if the traffic is mostly uplink centric, the weighting factors may be set as w₁=1, w₂=0, where this setting would allow the device to select the cell with the highest coupling gain; and if the downlink traffic is relatively important, the weighting factors may be set as w₁=0.7, w₂=0.3.

Using the general terms of above, there is may optionally be considered that the coupling gain has an associated first weighting coefficient and each of the at least one further parameter has an associated respective further weighting coefficient. Then, the weighted average may be defined by the first weighting coefficient and at least one further weighting coefficient. The first weighting coefficient and each at least one further weighting coefficient should together sum to unity. Beneficially, the first weighting coefficient and the at least one further weighting coefficient are determined on the basis of a split between uplink traffic and downlink traffic for the cellular device. In other words, the parameter based on the received power level for the respective cell at the cellular device may have an associated second weighting coefficient, the first weighting coefficient being set in accordance with a proportion of uplink traffic for the cellular device (in relation to the total traffic) and the second weighting coefficient being set in accordance with a proportion of downlink traffic for the cellular device (in relation to the total traffic).

The foregoing explains how the device can carry out initial cell selection, when it has no knowledge of the RF channels. Equally, this technique can be also used with stored information. This stored information can therefore also be updated to include the recent cell selection information based on coupling gain, for instance the coupling gain and/or the cell transmission power level (and PSD boosting). In general terms, the step of determining the selection metric for each cell of the plurality of cells may comprise: using a stored selection metric for each cell of the plurality of cells, especially if stored selection metrics for the plurality of cells are available; and/or calculating the selection metric for each cell of the plurality of cells and storing the calculated selection metrics, particularly if selection metrics for the plurality of cells have not previously been calculated.

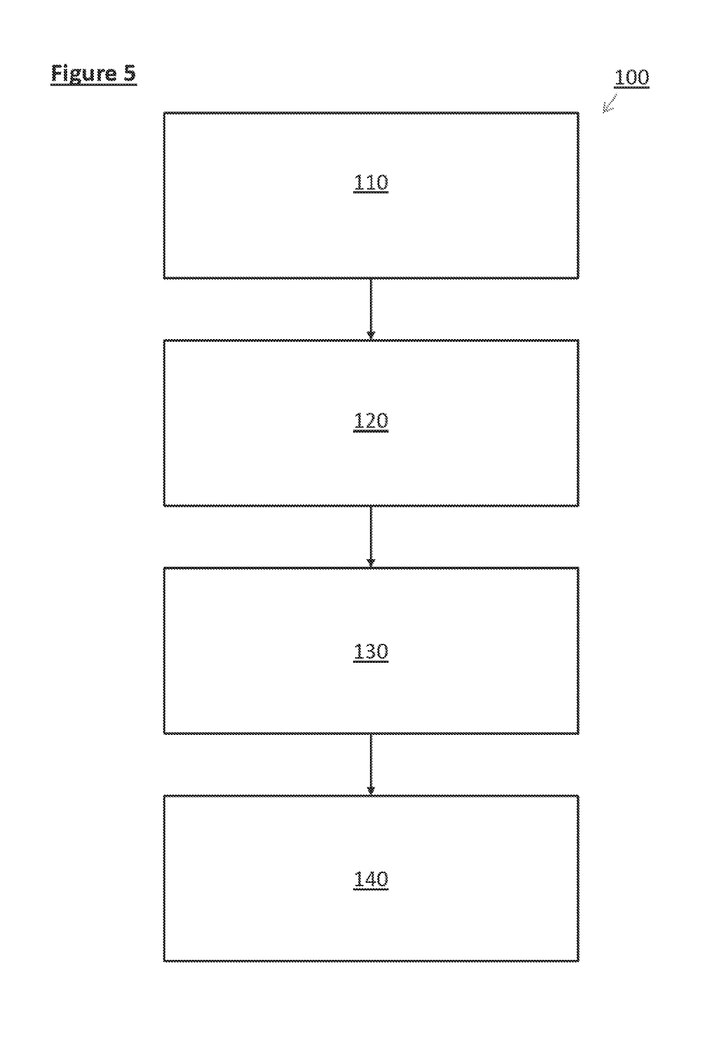

Referring now to FIG. 5, there is illustrated a flowchart of a mode of operation 100 for a cellular device in accordance with the disclosure. In the first step 110, all available cells in the PLMN are accessed. Then in the second step 120, the “S” criterion is modified to: (a) replace RSRP with a criterion based on path loss (coupling gain); and (b) give “weighted” points for RSRP-based and path loss-based metrics. In the third step 130, cell selection takes place. A cell that is most suitable for uplink operation, in other words with the lowest path loss (highest coupling gain), is selected. The cellular device then camps on the selected cell and begins to operate.

Cell reselection occurs when a device is camped and either the serving cell signal strength (RSRP) becomes poor or when a suitable high strength neighbour cell becomes available. In NB-IoT cell reselection process is not expected to be common as the data transmission is typically infrequent. The procedure for cell re-selection is similar to that for cell selection, but follows the differences between cell selection and cell re-selection that are in existing 3GPP specifications, as will now be discussed. In general terms, it should be noted that the term selecting used above equally covers reselecting.

Firstly, the device will only consider cells meeting the minimum “S” criterion discussed above. Thus, the modified “S” criterion can equally be used for re-selection as for first selection. When evaluating S_rxlev and S_qual of non-serving cells for reselection purposes, the device uses parameters provided by the serving cell. In order to avoid triggering inter-frequency and intra-frequency UE measurements too often, “two-step” thresholds are proposed, such that S_rxlev and S_qual in cell selection may different from cell reselection. In the general terms discussed above, it was noted that the method may comprise identifying some cells from the plurality of cells that meet a cell selection criterion, which preferably defines a threshold. In this case, if the mobile is not already receiving service from a cell, the threshold may be set at a first level and if the mobile is already receiving service from a cell, the threshold may be set at a second level. In particular, the second level is more stringent than the first level.

Then, the device performs a ranking of all cells that fulfil the cell selection criterion. Typically, the known “R” criteria are used (as defined in 3GPP TS 36.304). The parameters of Q_{meas,n} and Q_{meas,s} are derived and the R values calculated using averaged RSRP results. This ranking should additionally be based, at least in part, on the selection metric discussed above, defined using the coupling gain. In particular, the metric of (w₁*Coupling_gain+w₂*RSRP) may be used. The R values are updated to include or prioritised to include cells with better coupling gain.

Thus in general terms, the step of selecting a cell from a plurality of cells may comprise: ranking the identified some cells on the basis of: the respective selection metric associated with each cell of the identified some cells, the highest ranked of the identified some cells being the selected cell. The step of ranking may additionally be made on the basis of: at least one respective performance value associated with each cell of the identified some cells. The performance values may be the “R” criteria discussed above or another criteria based on received signal power level. Such approaches may be particularly applied if the mobile is already receiving service from a cell. Optionally, the step of ranking prioritises cells based on their respective selection metrics, particularly if the mobile is already receiving service from a cell.

Although specific embodiments have now been described, the skilled person will understand that various modifications and variations are possible. Although the approach described herein has been specifically applied to NB-IoT devices, it will be understood that this can be more widely applied, although specific advantages may apply particularly when devices operating in a narrow band and/or uplink traffic-centric devices and/or IoT devices and/or low energy (high battery lifetime) devices are considered. It will also be appreciated that variations or alternatives to the “S” and “R” criteria discussed above may be considered without affecting the implementation of the approach provided herein significantly. In scenarios where PSD boosting is not used, this may need not be considered or even communicated from the cell to the cellular device.

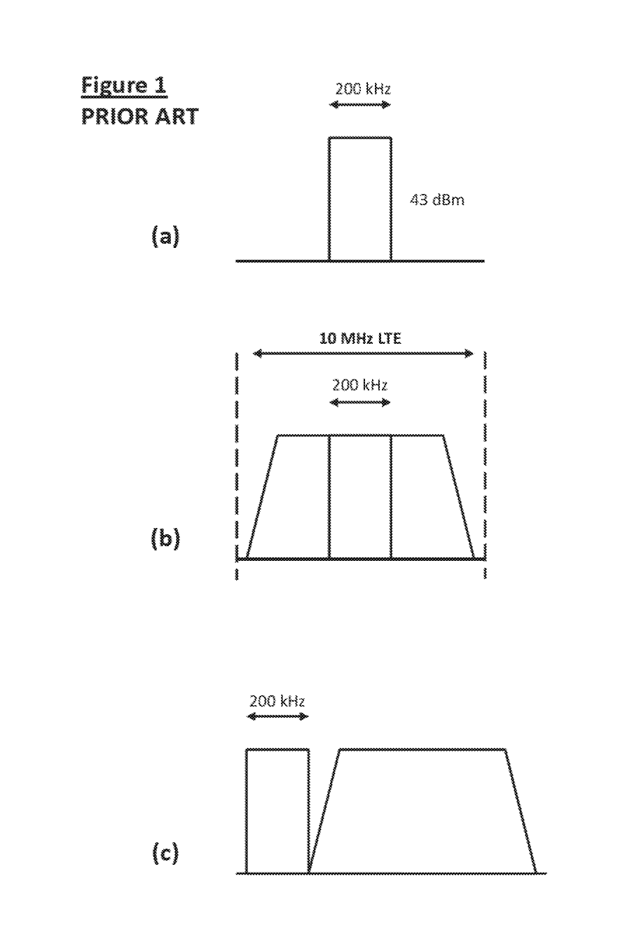

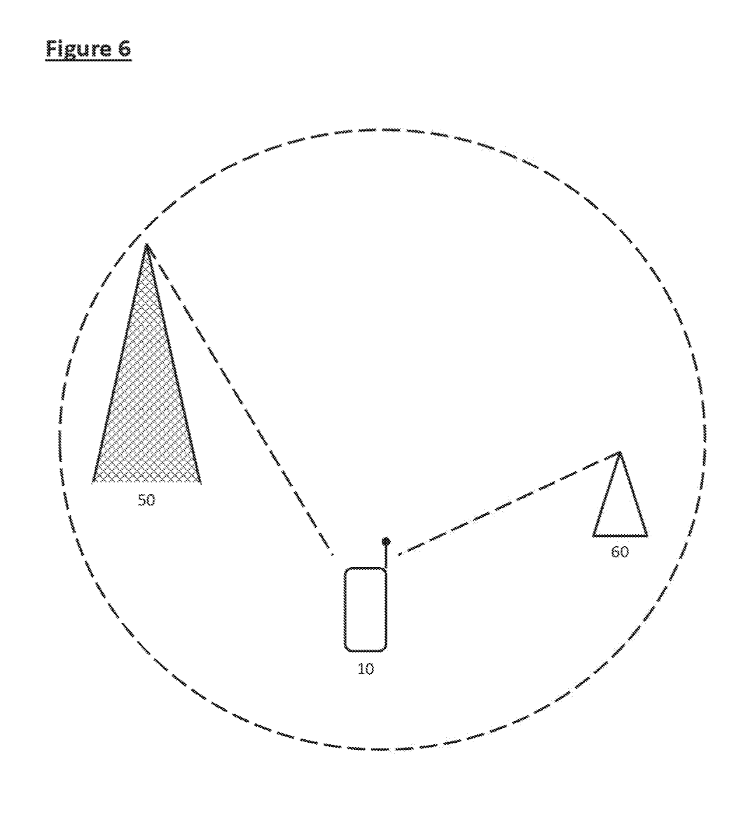

The foregoing has been discussed with reference to a conventional cell service arrangement in which a cellular device receives services from only one cell provides service at any one time, but variants on this are possible. Some such variants are well known. In one such variant, a heterogeneous network can be considered. Referring to FIG. 6, there is diagrammatically shown a cellular device 10 selecting cells in a heterogeneous network mode. The cellular device 10 is being served by both a macro cell 50 and a small cell 60 (pico-cell or femto-cell). The macro cell may use any of the deployment modes shown in FIG. 1. The same procedures as identified above can be applied in this scenario. Similar, a relay scenario may be considered and the same procedures as identified above are still applicable.

With reference to the general terms discussed above, this may be considered as a heterogeneous network configuration, possibly with different cells having different transmission power levels. The cellular device may be configured to receive service from more than one cell of the plurality of cells in such a configuration. Preferably, the heterogeneous network configuration is one in which the cellular device is served by either a macro-cell or a small cell (such as a femto-cell or pico-cell).

Combinations of any aspects, specific features shown with reference to one embodiment (or general disclosure) or with reference to multiple embodiments (general disclosures) are also provided, even if that combination has not been explicitly detailed herein. Any of the methods disclosed herein may be provided in the form of a computer program configured to perform the respective method when operated by a processor. A computer readable medium storing such a computer program may further be provided. In addition, an entity for operation in a cellular network, configured to perform any of the methods disclosed herein may be considered. Such an entity may be a cellular device, especially a IoT device (such as a NB-IoT device), or a cell controller. A cell comprising such a cell controller may further be considered. The entity may have structural features such as a transmitter, receiver and/or processor, configured to perform individual method steps discussed above.

1. A method for selecting a cell from which a cellular device is to receive service, the cell being selected from a plurality of cells in a cellular network, the method comprising:
determining a selection metric for each cell of the plurality of cells, each selection metric being based on a transmission power level for the respective cell and a received power level for the respective cell at the cellular device, such that the selection metric reflects an uplink performance characteristic between the cellular device and the respective cell; and
selecting a cell from the plurality of cells based on the respective selection metric for each cell.

2. The method of claim 1, wherein at least one cell from the plurality of cells transmits a relatively wide bandwidth carrier and communicates with the cellular device over a relatively narrow bandwidth, the transmission power level for the cell being in respect of the narrow bandwidth used for communicating with the cellular device.

3. The method of claim 1 or claim 2, wherein the step of determining a selection metric for each cell of the plurality of cells comprises determining a coupling gain for each cell, the coupling gain representing a gain from the transmission power level for the respective cell to the received power level for the respective cell at the cellular device.

4. The method of claim 3, wherein the selection metric for each cell of the plurality of cells is defined by the coupling gain for the respective cell and at least one further parameter of the respective cell.

5. The method of claim 4, wherein the selection metric for each of the plurality of cells is a weighted average of the coupling gain and the at least one further parameter and wherein the coupling gain has an associated first weighting coefficient and each of the at least one further parameter has an associated respective further weighting coefficient, the weighted average being defined by the first weighting coefficient and at least one further weighting coefficient and wherein the first weighting coefficient and the at least one further weighting coefficient are determined on the basis of a split between uplink traffic and downlink traffic for the cellular device.

6. The method of any preceding claim, further comprising:
identifying some cells from the plurality of cells that meet a cell selection criterion; and
wherein the step of selecting a cell from a plurality of cells comprises comparing the respective selection metrics of each of the identified some cells.

7. The method of claim 6, wherein the cell selection criterion defines a threshold and wherein if the mobile is not already receiving service from a cell, the threshold is set at a first level and if the mobile is already receiving service from a cell, the threshold is set at a second level, the second level being more stringent than the first level.

8. The method of claim 6 or claim 7, wherein the step of selecting a cell from a plurality of cells comprises:
if the mobile is not already receiving service from a cell, selecting the cell from the identified some cells with a selection metric corresponding with the best performance; and/or
if the mobile is already receiving service from a cell, ranking the identified some cells on the basis of: at least one respective performance value associated with each cell of the identified some cells; and the respective selection metric associated with each cell of the identified some cells, the highest ranked of the identified some cells being the selected cell.

9. The method of claim 8, wherein if the mobile is already receiving service from a cell, the step of ranking prioritises cells based on their respective selection metrics.

10. The method of any preceding claim, wherein the step of determining the selection metric for each cell of the plurality of cells comprises:
using a stored selection metric for each cell of the plurality of cells, if stored selection metrics for the plurality of cells are available; and/or
calculating the selection metric for each cell of the plurality of cells, if selection metrics for the plurality of cells have not previously been calculated, and storing the calculated selection metrics.

11. The method of any preceding claim, further comprising:
measuring the received power level for each cell of the plurality of cells at the cellular device, the measuring being over one or multiple subframes of a physical layer protocol of the cellular network and/or being made until an accuracy of the measured received power level is within 3 dB.

12. The method of any preceding claim, further comprising:
communicating information about a transmission power level for a cell, from the cell to the cellular device.

13. A method of operating a cell in a cellular network comprising a plurality of cells, the method comprising:
communicating from the cell over a broadcast channel or a system information channel, information about a transmission power level for the cell, for reception by a cellular device that is selecting a cell from the plurality of cells from which the cellular device is to receive service.

14. The method of claim 12 or claim 13, wherein the cell transmits a relatively wide bandwidth carrier and communicates with the cellular device over a relatively narrow bandwidth, the information about the transmission power level comprising: information about a transmission power level for the relatively wide bandwidth carrier; and information about power spectral density boosting in respect of the narrow bandwidth used for communicating with the cellular device.

15. The method of any preceding claim, wherein the cellular device is configured to receive service from more than one cell of the plurality of cells, in a heterogeneous network configuration.

16. An entity for operation in a cellular network, configured to perform the method of any preceding claim.
